(19) United States
(12) Patent Application Publication
(10) Pub. No.: US 2019/0262099 A1
(43) Pub. Date: Aug. 29, 2019

(54) TOOTH EXTRACTION DENTAL PLIERS

(71) Applicant: Lori Lee Lahti, (US)

(72) Inventors: Lori Lee Lahti, McDougall (CA); Bartek Zalewski, Richmond Hill (CA); Ronald Thatcher, Ontario (CA); Chris Pearen, King City (CA)

(21) Appl. No.: 15/904,810

(22) Filed: Feb. 26, 2018

(51) Int. Cl. A61C 3/14

(52) U.S. Cl. CPC A61C 3/14; B25B 7/02

(57) ABSTRACT

A pair of dental pliers for use by a parent to extract a non-permanent tooth from a child's mouth. The dental pliers include a left leg and a right leg that are pivotally engaged with each other. Each of the left and right legs has a handle and a jaw. The handles are fabricated from a flexible material that flexes when too much force is applied thereto when moving the jaws to a closed position. The flexible handles thus limit the amount of force that may be applied to extract a tooth. The jaws include jaw tips that taper inwardly toward each other and angle downwardly from the handles. The jaw tips include angled interior surfaces that define a cupped region shaped to be able to contact a base of the tooth during the extraction process. The pliers are able to be cleaned and sanitized in a dishwasher after use.

### BACKGROUND

### Technical Field

This invention is directed generally to dental equipment. More particularly, this invention relates to dental extraction tools. Specifically, the present invention is a pair of dental pliers that may be used by a parent or care-giver to extract a non-permanent tooth of a child in a setting outside of a dental office. The dental pliers include flexible handles that limit the force that is able to be applied to a tooth when captured in a cupped region of the pliers jaws.

### Background Information

There are many types of dental extracting forceps that are known in the art for use when extracting permanent adult teeth. These dental forceps, which are also known as dental pliers, are typically machined from stainless steel. They include a pair of handles that are pivotally engaged with each other. Each handle has a jaw at one end and the jaws may be moved toward or away from each other by manipulating the handles. The jaws may be differently configured from one pair of dental forceps to another. Some types of dental forceps have straight jaws, others have angled jaws and yet others have a combination of straight and angled jaws. Typically, the jaws are configured such that there is a slightly cupped shape proximate and end of the jaws. The cupped region is provided to engage a tooth shape. Dental forceps are very strong and must be thoroughly cleaned and sterilized in an autoclave after each use. An autoclave uses high heat and steam to sterilize and clean the instrument.

The force needed to grip dental forceps and extract a permanent adult tooth can be surprisingly high for the dentist. An extraction procedure for an adult molar with two or three roots may often begin with a twisting rotational movement to try to loosen the roots. The rotational motion may be followed by a firm pulling motion. Care must be taken so the roots do not break off the tooth and remain in the jaw where they may subsequently cause infection. Often a dentist of slight build may prepare the patient and then summon a larger or stronger associate to perform the pulling motion.

Non-permanent teeth, also known as baby teeth, typically fall out by themselves when the child or young person is around six to twelve years old. Non-permanent teeth typically have no significant roots and are attached to soft tissue. They can therefore fall out of the child's mouth while the child is sleeping, spitting out (during brushing of their teeth, for instance), or they may fall out during eating and may be accidentally ingested. A non-permanent tooth may be become “wiggly” and take several days to become sufficiently disengaged from the soft tissue. The tooth may tend to rotate, get stuck on other teeth and generally become a nuisance and a stressor for the young child. Often parents will try to assist the process by pulling the loose tooth with their fingers as best they can. In other instances, they will try “home remedies” such as tying a piece of string around the tooth at one end and a door-knob at the other in order to remove the loose tooth from the child's mouth. All of these attempts at tooth removal may be somewhat distressing to the child and to the parent.

Once a loose tooth is removed and, in order to make this whole process less stressful and slightly rewarding for the child, the tooth will be put under the child's pillow or in some specially designated spot or receptacle and the mythical “Tooth Fairy” will come and replace the tooth with a coin or other reward while the child sleeps.

### SUMMARY

There remains a need in the art for a better way to help a parent remove a loose non-permanent tooth from a child's mouth. The dental pliers disclosed herein provide this assistance. The dental pliers include a left leg and a right leg that are pivotally engaged with each other. Each of the left and right legs has a handle and a jaw. The handles are fabricated from a flexible material that flexes when too much force is applied thereto to move the jaws to a closed position. The flexible handles thus limit the amount of force that may be applied to extract a tooth. The jaws include jaw tips that taper inwardly toward each other and angle downwardly from the handles. The jaw tips include angled interior surfaces that define a cupped region shaped to be able to contact a base of the tooth during the extraction process. The pliers are able to be cleaned and sanitized in a dishwasher after use.

In one aspect, the present disclosure may provide a pair of dental extraction pliers comprising a left leg having a handle and a jaw; a right leg having a handle and a jaw; wherein the handles are fabricated from a flexible material; a pivot pin engages the left and right legs to each other; wherein the handles are movable towards each other or away from each other; and when the handles are moved towards each other, the jaws are moved toward each other; and the flexible material of the handles limits a force that is applied by the jaws.

In other aspects, the present disclosure may provide a pair of dental pliers where the jaws include jaw tips that angle forwardly and downwardly relative to a remaining region of the jaws and the handles. The jaw tips angle downwardly at an angle of from about 110 degrees up to about 140 degrees and preferably is about 125 degrees relative to the remaining region of the jaws and the handles. The jaw tips taper inwardly towards each other when the pair of dental pliers is viewed from above or when the pair of dental pliers is viewed from a front end. The jaw tips have interior surfaces that are oriented at an angle of from about 10 degrees up to about 40 degrees and preferably about 25 degrees relative to an adjacent region of the jaw; the interior surfaces are opposed when the handles are moved to the closed position; and when the handles are in the closed position the opposed interior surfaces form a cupped region adapted to receive a tooth therein.

In other aspects, the present disclosure may provide a pair of dental pliers that further comprise a spring extending between the handles. A first spring housing extends outwardly from an interior surface of the handle on the left leg and a second spring housing extends outwardly from an interior surface of the handle on the right leg. A first end of the spring is seated in the first spring housing and a second end of the spring is seated in the second spring housing. The first spring housing abuts the second spring housing when the handles are moved to the closed position. The spring biases the handles into the open position.

In other aspects, the present disclosure may provide a pair of dental pliers that includes handles made of a flexible material such as an injection molded plastic that is overmolded with rubber. The jaw tips of the jaws are fabricated from metal such as die-cast aluminum. The pair of dental pliers is fabricated from dishwasher-safe materials.

In another aspect, the present disclosure may provide a method using a pair of dental pliers comprising providing a pair of dental pliers having pivotable left and right legs each having a handle and a jaw; wherein the handles are fabricated from a flexible material; positioning jaw tips of the jaws in the child's mouth on either side of a non-permanent tooth that is loosely retained in the soft tissue of the child's gum; positioning angled interior surface on the jaw tips adjacent a base of the non-permanent tooth; applying a force to the handles; moving the jaws toward each other; capturing the non-permanent tooth between the angled interior surfaces; limiting an amount of force able to be applied to the non-permanent tooth by the jaws; applying a pulling motion to the captured non-permanent tooth; and extracting the non-permanent tooth from the soft tissue.

In another aspect, the present disclosure may provide a method wherein the step of limiting comprises flexing the flexible material of the left leg handle and the right leg handle inwardly toward each other once a maximum threshold force is applied to the left and right leg's handles. Alternatively, the step of limiting may comprise abutting a first spring housing provided on the handle of a left leg of the dental pliers against a second spring housing provided on the handle of a right leg of the dental pliers; and stopping motion of the jaw of the left leg and the jaw of the right leg towards each other.

In yet another aspect, the present disclosure may provide a method that includes placing the dental pliers into a dishwasher after extraction of the non-permanent tooth; and cleaning and sanitizing the dental pliers in the dishwasher. The method may further comprise a use of the dental pliers described above by a parent or a care-giver of the child in a setting outside of a dental office.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top perspective view of dental tooth extraction pliers in accordance with an aspect of the present disclosure;

FIG. 2 is a top plan view of the pliers of FIG. 1;

FIG. 2A is an exploded top plan view of the pliers;

FIG. 3 is a right side elevation view of the pliers;

FIG. 4 is a front elevation view of the pliers;

FIG. 5 is an enlarged cross-section of one jaw of the pliers taken along line 5-5 of FIG. 4;

FIG. 6 is an enlarged top plan view of a front end of the pliers with the jaws thereof positioned to grasp a tooth for extraction;

FIG. 7 is an enlarged cross-section of one jaw of the pliers taken along line 7-7 of FIG. 4;

FIG. 8 is a diagrammatic side view of a front end of the pliers positioned in a patient's mouth for extraction of a tooth from the lower jaw;

FIG. 9 is an enlarged top view of the pliers showing the angled faces on the jaw tips;

FIG. 10 is a diagrammatic view of the front end of the pliers engaging a patient's tooth and showing the angular faces at the front end seated along the base of the tooth;

FIG. 11 is a top, rear perspective view of the pliers being held in a dentist's hand;

FIG. 12 is a top plan view showing in phantom a second position of the handles of the pliers; and

FIG. 13 is an exploded right side view of the pliers;

Similar numbers refer to similar parts throughout the drawings.

### DETAILED DESCRIPTION

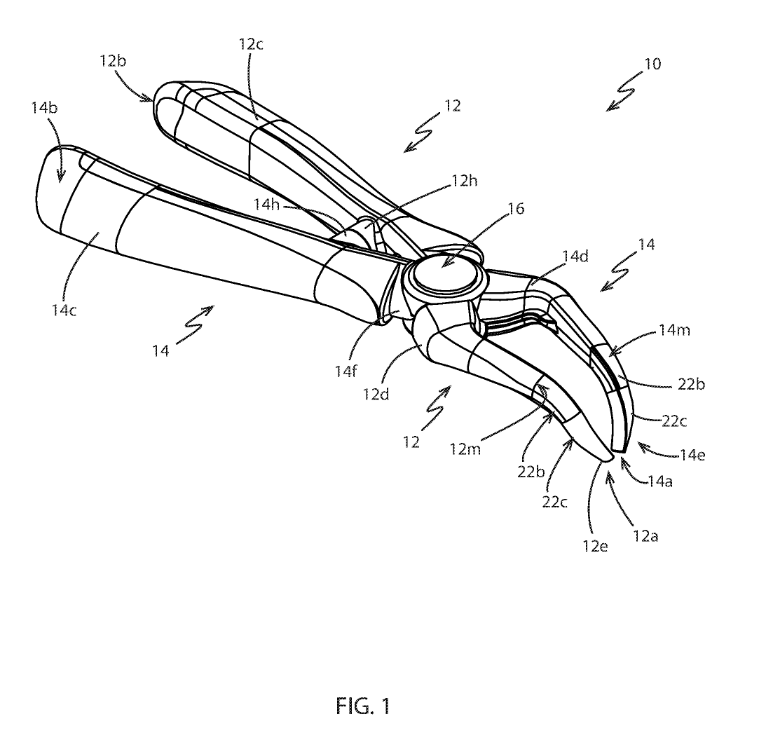

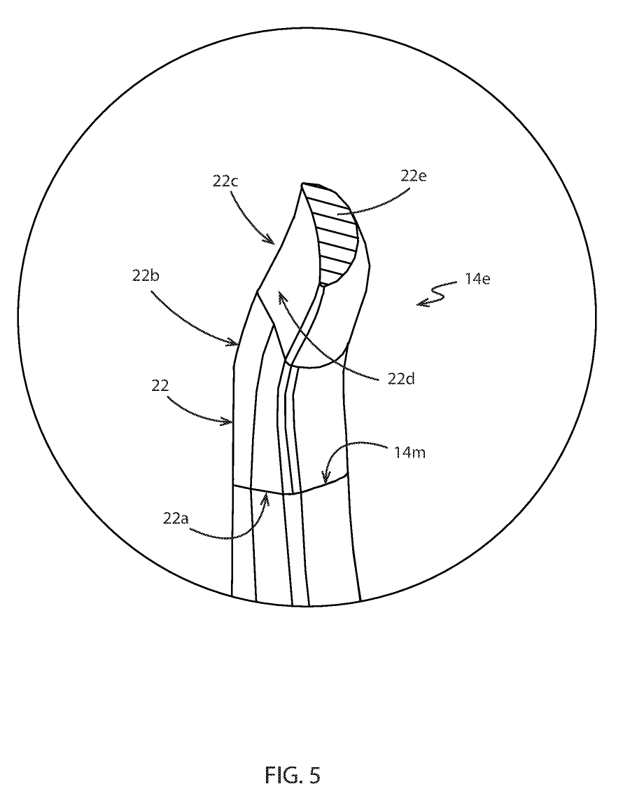

Referring to FIGS. 1-13, there is shown a pair of dental pliers in accordance with an aspect of the present disclosure, generally indicated at 10. Pliers 10 are designed to be usable by parents or care-givers of young children who are not professionals when it comes to extracting teeth. These parents therefore tend to lack the knowledge, experience and skill that a dentist has. As a consequence, pliers 10 have been designed to be a light-weight, easy to use tool that may be purchased at a relatively low price point as it may only be used a few times in the life of the tool. Pliers 10 are fabricated from materials that allow the device to be washed in a dishwasher. Because pliers 10 will tend to be used within a family, there is little chance of infection and there is therefore no need to autoclave the device. Washing pliers 10 in the dishwasher is sufficient to clean the device for future use.

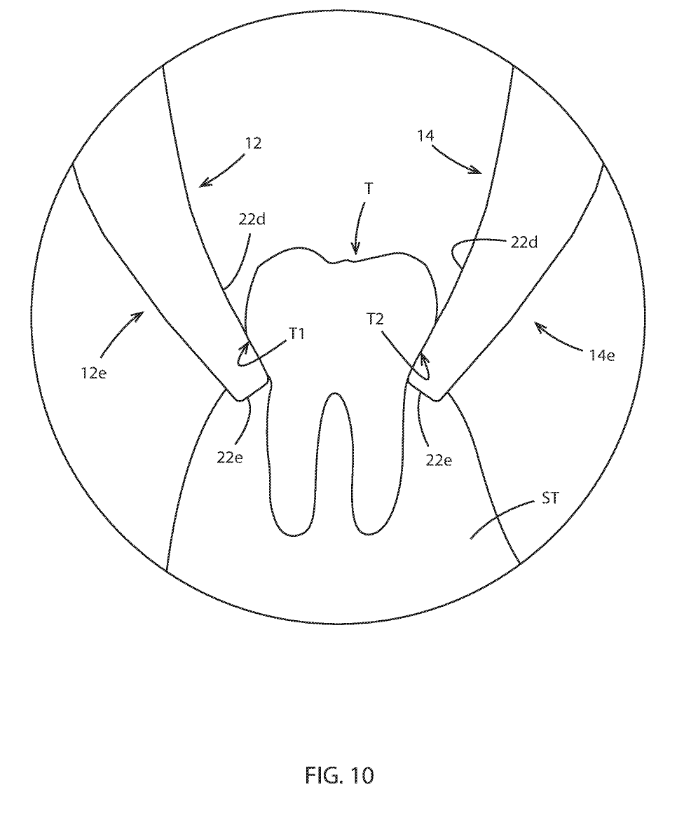

Since a parent or care-giver should only be extracting an already loose, wiggly tooth (“T”—see FIG. 10) from soft tissue “ST”, not much force needs to be applied to pliers 10 to grasp and extract tooth “T”. Pliers 10 therefore only need to be able to withstand a very low force being applied thereto. It should be noted that pliers 10 are not designed to be used to pull tooth “T” before the tooth has become loose and wiggly and is ready to be pulled. Pulling a tooth before it is ready to be pulled may cause bleeding and soft tissue damage.

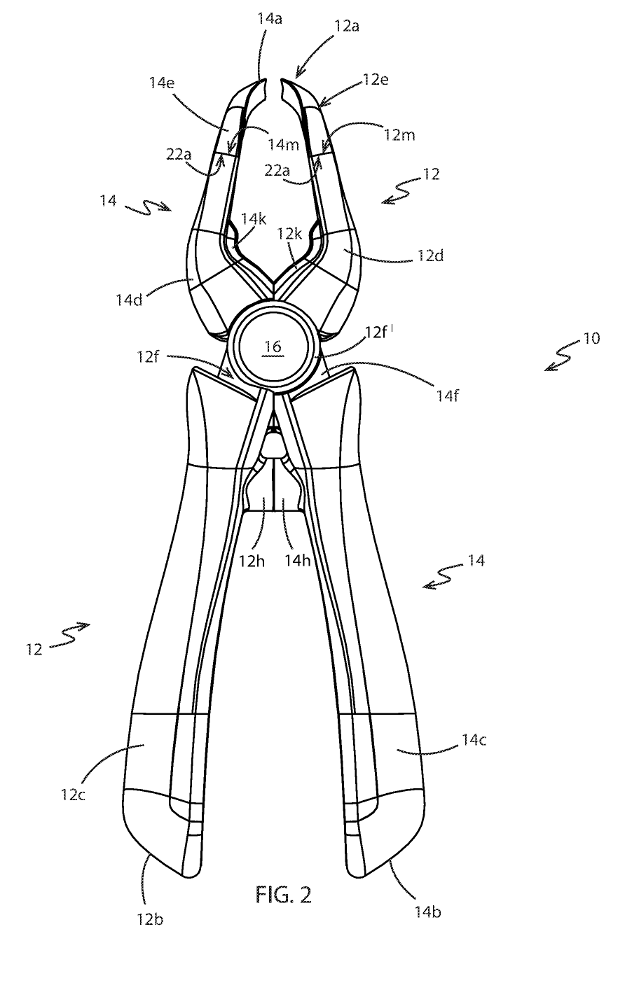

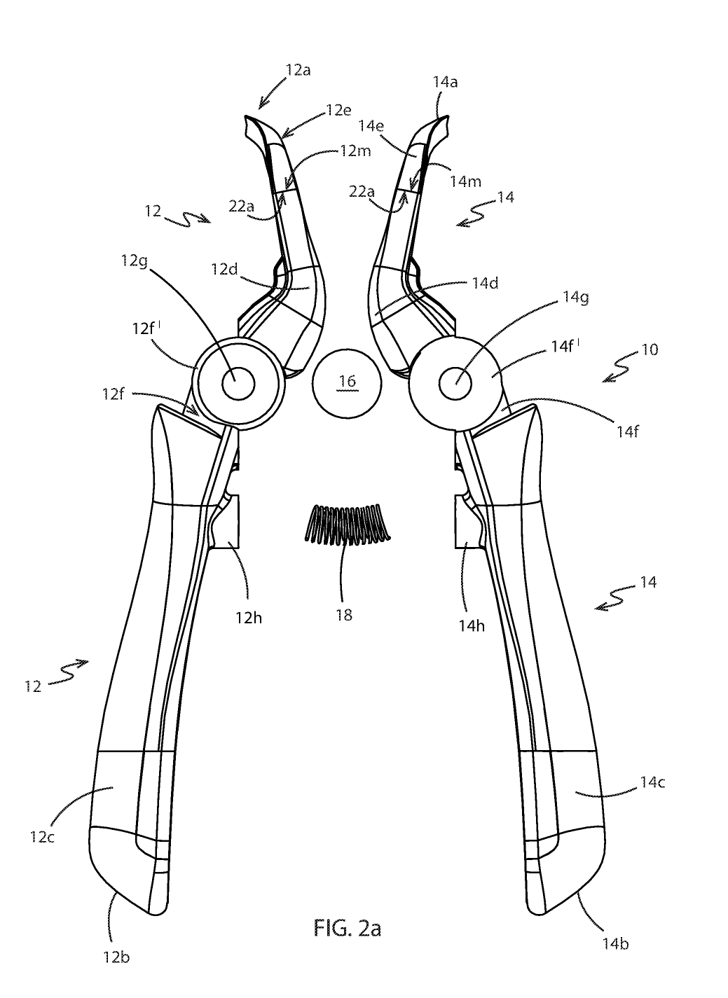

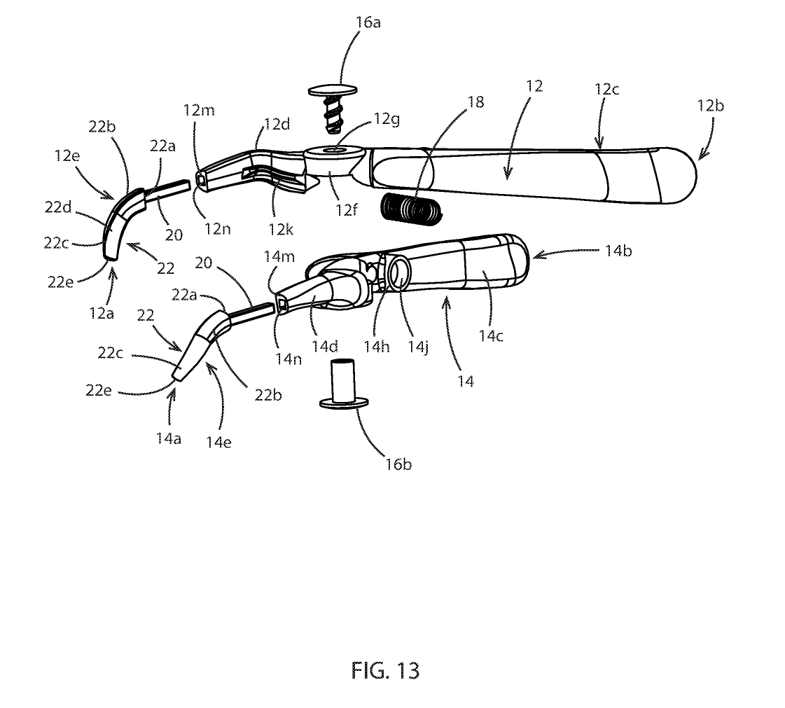

Pliers 10 comprise a left leg 12, a right leg 14, and a pivot pin 16 that engages the left leg 12 and right leg 14 to each other. A spring 18 (FIG. 13) extends between the left leg 12 and right leg 14 as will be discussed later herein. As shown in FIG. 2, left leg 12 has a front end 12a and a rear end 12b. Left leg 12 comprises a handle 12c and a jaw comprised of a base 12d and a jaw tip 12e. Handle 12c may be ergonomically configured for easy gripping by a user. Handle 12c and base 12d may be separated from each other by a neck section 12f.

Handle 12c, neck section 12f and base 12d may be molded as a single, integrally formed, unitary component or may be fabricated as separate sections that are secured together. Handle 12c, neck section 12f and base 12d may be fabricated from a relatively inexpensive injection molded plastic such as polypropylene. This plastic may be brightly colored to give the pliers 10 a more playful and child-friendly appearance. Handle 12c may be provided with a rubber overmold to assist a parent or care-giver to grip pliers 10. Neck section 12f may be molded to be generally narrower and thinner than either handle 12c or base 12d and may include a collar 12f′ having a front surface and a back surface. A hole 12g (FIG. 2A) may be defined in the collar 12f′ of neck section 12e and hole 12g may extend from the front surface of collar 12f′ to a back surface thereof.

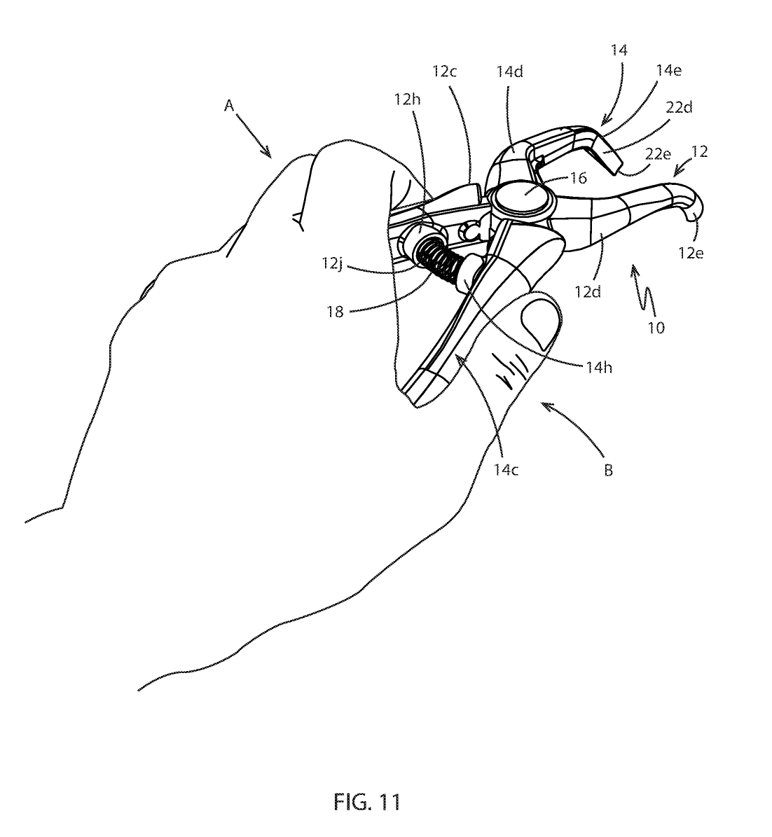

FIGS. 2A, 11 and 13 show that a spring housing 12h is molded as part of handle 12c. Spring housing 12h comprises an annular wall that extends outwardly from an interior surface of handle 12c a short distance inwardly from neck section 12e. The annular wall of spring housing 12h bounds and defines a central aperture 12j (FIG. 11). Aperture 12j is sized to be marginally bigger than the outer diameter of coil spring 18. Coil spring 18 may be fabricated from metal.

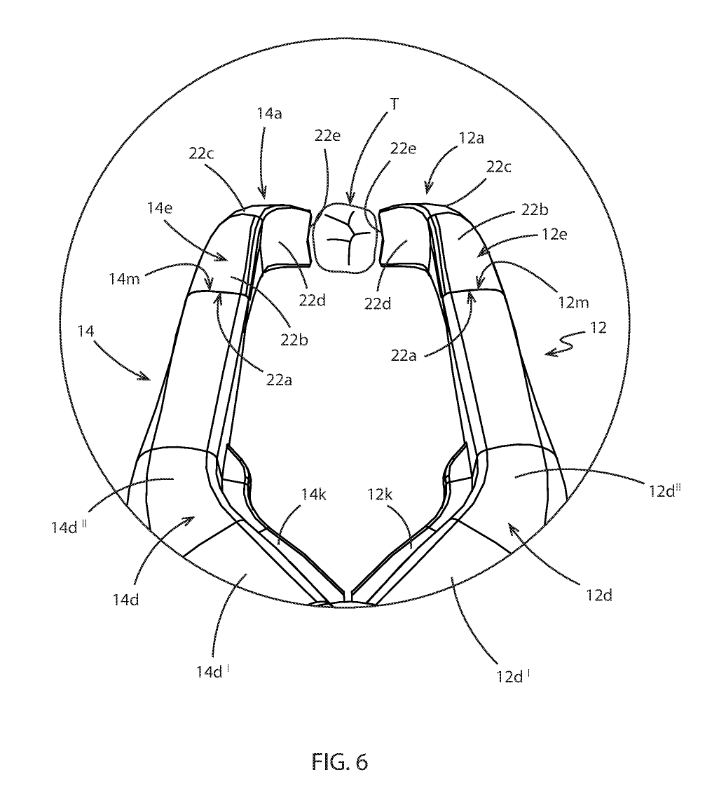

As best seen in FIG. 6, base 12d also includes a strengthening brace 12k that extends from a first region 12d′ of the interior surface of base 12d to a second region 12d″ of the interior surface of base 12d. First region 12d′ is oriented at an obtuse angle (i.e., greater than 90°) relative to second region 12″. Brace 12k helps to ensure that when pliers 10 are used, then first region 12d′ and second region 12d″ will remain engaged with each other and second region 12d″ will not shear off first region 12d′.

FIG. 13 shows that second region 12d″ of base 12d has a terminal end 12m that defines a socket 12n therein, Terminal end 12m may be generally square in cross-section and, similarly, socket 12n may be generally square in cross-section. Jaw tip 12e is configured to engage terminal end 12m as will be later described herein.

As shown in FIG. 2, right leg 14 is similarly configured to left leg 12 and is fabricated in the same materials and in the same manner as left leg 12. Right leg 14 has a front end 14a and a rear end 14b. Right leg 14 comprises a handle 14c and a jaw comprised of a base 14d and a jaw tip 14e. Handle 14c may be ergonomically configured for easy gripping by a user. Handle 14c and base 14d may be separated from each other by a neck section 14f. Neck section 14f may include a collar 14f′ having a front surface and a back surface. A hole 14g (FIG. 2A) may be defined in the collar 14f′ of neck section 14e and hole 14g may extend from the front surface of collar 14f′ to a back surface thereof.

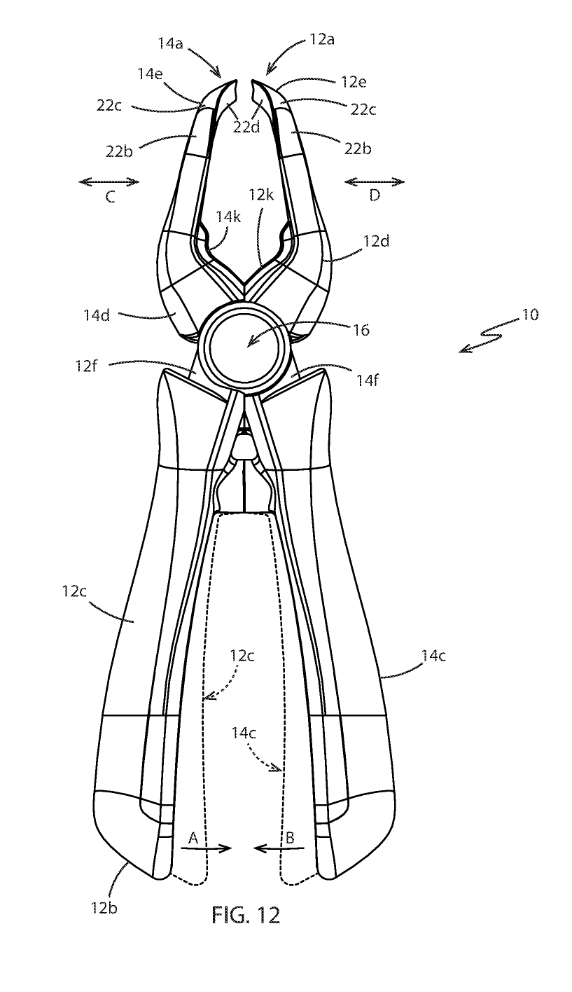

FIGS. 2A, 11 and 13 show that a spring housing 14h is molded as part of handle 14c. Spring housing 14h comprises an annular wall that extends outwardly from an interior surface of handle 14c a short distance inwardly from neck section 14e. The annular wall of spring housing 14h bounds and defines a central aperture 14j (FIG. 13). Aperture 14j is sized to be marginally bigger than the outer diameter of coil spring 18. When left and right legs 12, 14 are assembled into pliers 10 (as will be described later), spring housing 12h and spring housing 14h are substantially aligned with each other as can be seen in FIG. 2. A first end of spring 18 is seated in spring housing 12h and a second end of spring 18 is seated in spring housing 14h. When a force is applied to handles 12c and 14c when a parent or care-giver grips pliers 10 to position jaw tips 12e, 14e on either side of a tooth, handles 12c and 14c are moved inwardly towards each other and spring 18 is compressed. When force is no longer applied to handle 12c, 14c, spring 18 returns to its uncompressed state and this moves handles 12c and 14c away from each other. It should be noted that the application and release of force to handles 12, 14 causes jaw tips 12e, 14e to move relative to each other. Jaw tips 12e, 14e are movable in the directions indicated by arrows “C” and “D” (FIG. 12) and are therefore movable toward each other to grasp a tooth “T” therebetween (as shown in FIG. 6) or away from each other to release an extracted tooth therefrom.

As best seen in FIG. 6, base 14d also includes a strengthening brace 14k that extends from a first region 14d′ of the interior surface of base 14d to a second region 14d″ of the interior surface of base 14d. First region 14d′ is oriented at an obtuse angle (i.e., greater than 90°) relative to second region 14″. Brace 14k helps to ensure that when pliers 10 are used, then first region 14d′ and second region 14d″ will remain engaged with each other and second region 14d″ will not shear off first region 14d′.

FIG. 13 shows that second region 14d″ of base 14d has a terminal end 14m that defines a socket 14n therein, Terminal end 14m may be generally square in cross-section and, similarly, socket 14n may be generally square in cross-section. Jaw tip 14e is configured to engage terminal end 14m as will be later described herein.

Neck sections 12f, 14f are configured to be complementary in the sense that they are shaped to be positioned adjacent each other and cooperate with pivot pin 16 to allow jaw tips 12d, 14d to be moved toward and away from each other. When left leg 12 and right leg 14 are to be engaged with each other the neck sections 12f, 14f are overlapped with each other. The neck sections 12f, 14f may be configured so that they are only able to overlap in one orientation so that jaw tips 12e and 14e will be correctly oriented in pliers 10. When neck sections 12f, 14f are overlapped, holes 12g, 14g are brought into alignment with each other.

Pivot pin 16 may be fabricated from a plastic material and may comprise complementary first section 16a (FIG. 13) and second section 16b. First section 16a of pivot pin 16 is inserted through the aligned holes 12g, 14g and is engaged in second section 16b. First and second sections 16a, 16b snap fit together in such a way that they cannot be accidentally disengaged from each other.

Jaw tips 12e and 14e may be fabricated as separate components that are then engaged with bases 12d and 14d, respectively. Jaw tips 12e, 14e may be die-cast aluminum components that are insert-molded with the associated bases 12d, 14d. The polypropylene used for the rest of the legs 12, 14 may be very soft and therefore a bit flexible. Applying sufficient force to extract a tooth would therefore be quite difficult. The aluminum die cast jaw tips 12e, 14e are sufficiently solid enough to accurately engage a tooth without slipping and are capable of applying sufficient force to grip and extract a loose tooth.

It should be noted that the materials used to fabricate pliers 10 are only a fraction of the cost of a machined, stainless steel pair of dental forceps such as those used by dentists. The materials used to fabricate pliers 10 are light-weight and non-corrosive. Because the handles 12c, 14c are made of a flexible material, they tend to limit the amount of force that can be applied by pliers 10 and therefore tend to make the pliers 10 safer and easier to use. The parent or care-giver, following instructions provided on an instruction sheet provided with pliers 10 will be able to extract loose non-permanent teeth relatively easily.

FIG. 13 shows jaw tips 12e, 14e in greater detail to each be comprised of include a shaft 20 and a head 22. Shaft 20 extends outwardly from an end 22a of head 22 and is shaped and sized to be complementary to the socket 12n or 14n on the base 12d or 14d with which the jaw tip is to be engaged. It should be noted that end 22a of head 22 is of a similar shape and size to the terminal end 12m or 14m of the associated base 12d, 14d.

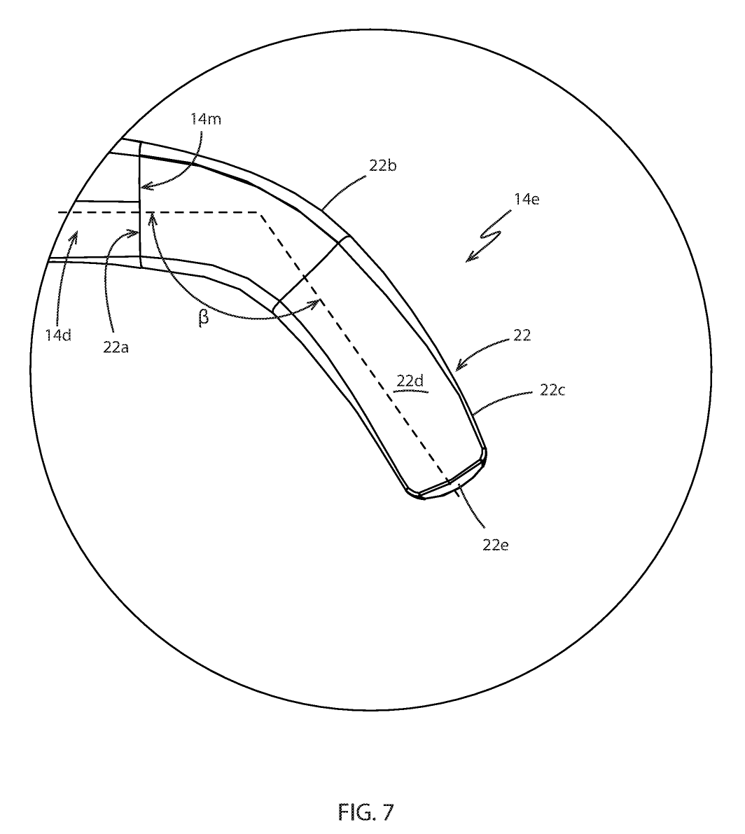

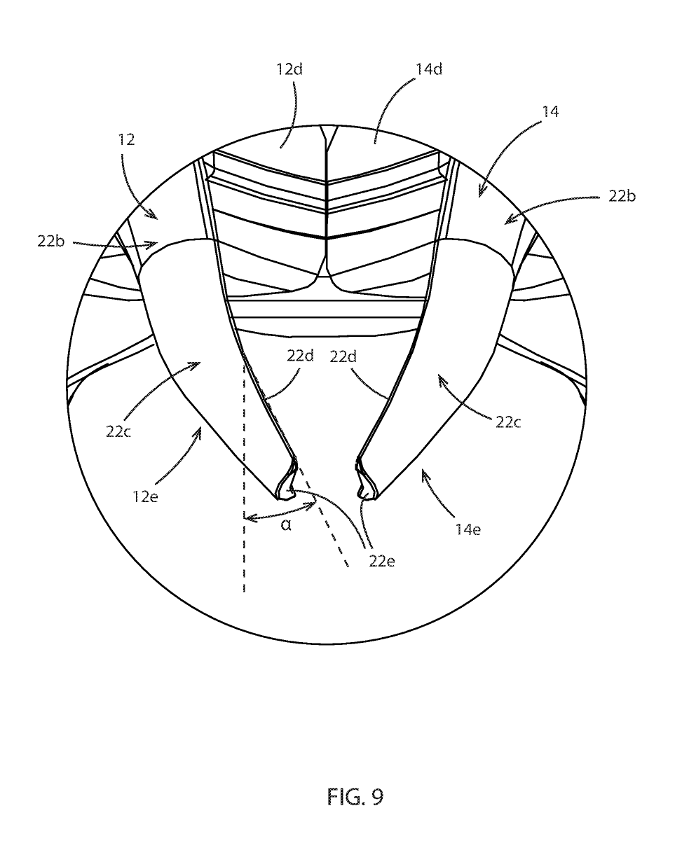

Head 22 is comprised of a first section 22b and a second section 22c. The end 22a is provided on first section 22b. When jaw tip 14e (FIG. 7) is engaged with base 14d, first section 22b of head 22 extends forwardly from terminal end 14m of base 14d and curves downwardly away therefrom. Second section 22c of each head 22 extends forwardly from first section 22b and curves downwardly from first section 22b. The curvature of second section 22c relative to first section is at an angle β (FIG. 7). The angle β may be from about 110 degrees up to about 140 degrees and preferably is about 125 degrees. The second section 22c includes an interior surface 22d (FIG. 9) that is oriented at an angle α relative to an adjacent region of the jaw. The angle α may be from about 10 degrees up to about 40 degrees and preferably is about 25 degrees. Second section 22c also includes an end face 22e.

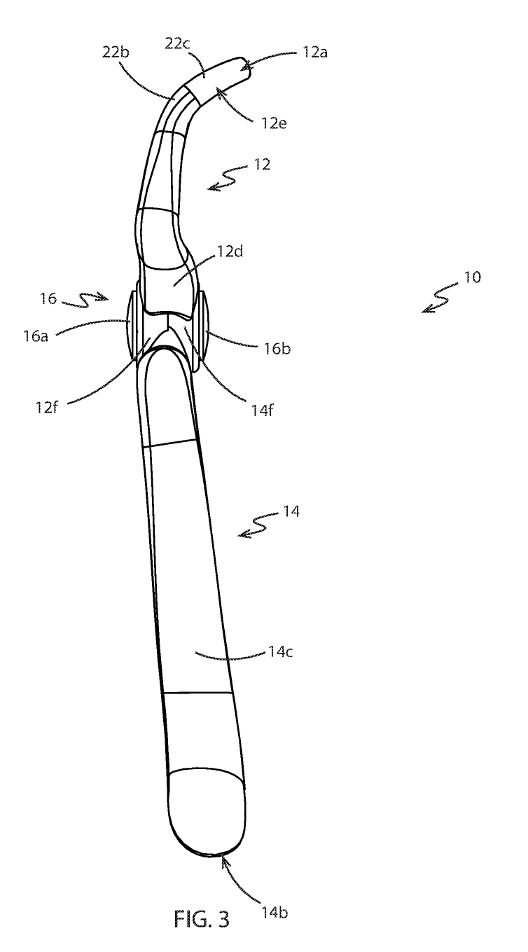

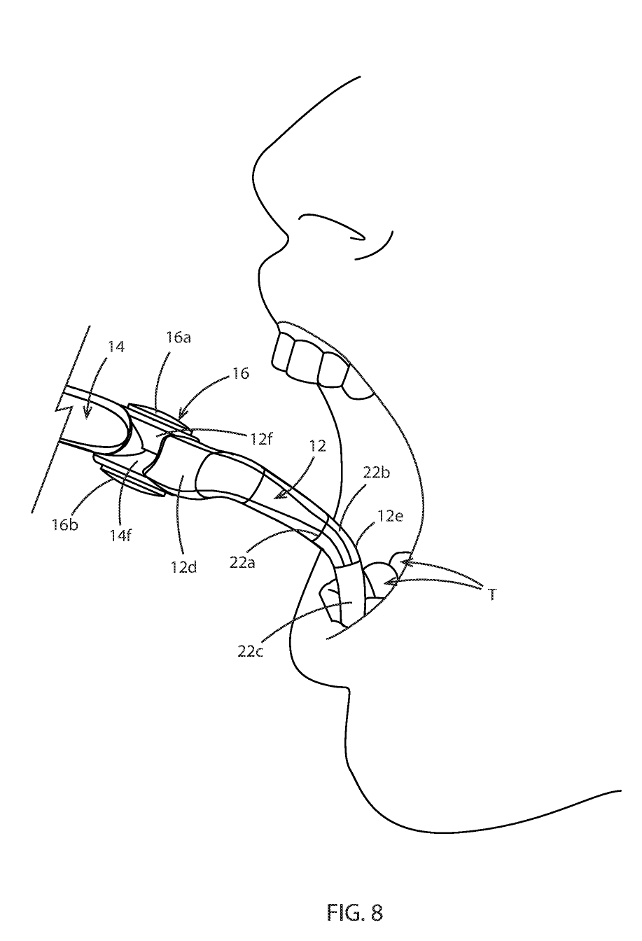

FIG. 3 shows that head 22 angles downwardly from base 12d at an angle that is generally at about 45°. This angle aids a parent or care-giver in inserting jaw tips 12e, 14e into a child's small jaw as can be seen in FIG. 8.

It should also be noted from FIGS. 2, 4 and 6 that second sections 22c of jaw tips 12e, 14e curve downwardly and inwardly toward each other so that the spacing between the interior surfaces of jaw tips 12e, 14e proximate terminal ends 12m and 14m is at a width of “W1” when pliers 10 are not being used. The spacing between terminal ends 22e, 22e on the bases 12d, 14d, respectively, are at a width “W2” apart. The width “W2” is smaller than the width “W1”. The downwardly and inwardly curved heads 22 on left leg 12 and right leg 14 therefore form a cupped region that is ideally suited to engage and grasp a tooth “T” in a young child's upper jaw or lower jaw (FIG. 8). FIG. 6 shows the cupped region of pliers 10 positioned to engage tooth “T”. FIG. 10 shows the cupped region of pliers 10 grasping tooth “T”. It is should be noted from FIG. 10 that the angles α of interior surfaces 22d of left leg 12 and right leg 14 tend to be complementary to the angles of the faces “T1” and “T2” on tooth “T”. When pliers 10 engage tooth “T” as illustrated in FIG. 10, the parent or care-giver may readily grasp tooth “T” to extract the same from the soft tissue “ST” of the child's gum. It should be noted that baby teeth (i.e., non-permanent teeth) may not have roots that extend into the soft tissue “ST” even though roots are illustrated in FIG. 10.

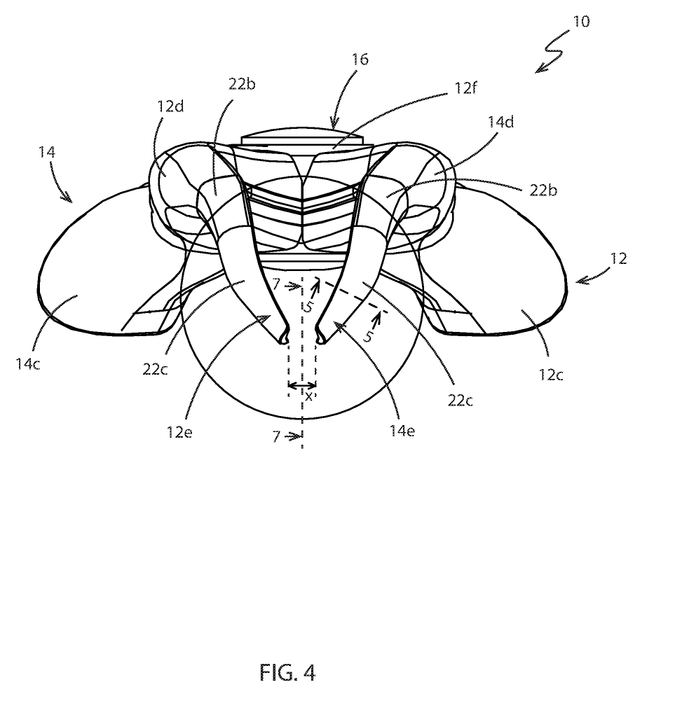

FIG. 11 shows pliers 10 held by a left-handed parent or care-giver (for ease of illustration only—the pliers 10 may be grasped as easily in the right hand). The parent or care-giver may apply force to left and right legs 12, 14 in the directions indicated by arrows “A” and “B”, respectively. Because left and right legs 12, 14 pivot about pivot pin 16 and because of the configuration of bases 12d, 14d, when force is applied in the directions “A” and “B” to legs 12, 14 of pliers 10, jaw tips 12e, 14e tend to move toward each other. This motion compresses spring 18. FIG. 12 shows the handles 12c, 14c in the open position (i.e., no force applied) but also shows the closed position of the handles 12c, 14c in phantom. It should be noted that when handles 12c, 14c are in the fully closed position, spring housing 12h contacts spring housing 14h. The contact between the two spring housings 12h, 14h limits the amount of force that may be applied to handles 12, 14. It should further be noted that when handles 12c, 14c are in the fully closed position shown in FIG. 12, a gap “X” (FIG. 4) remains between terminal end 22e of jaw tip 12e and terminal end 22e of jaw tip 14e. This too limits the amount of force that the parent or care-giver may apply to a child's tooth “T”.

Dental pliers 10 may be used by a parent or care-giver of a young child in a non-dental setting (i.e., in a location such as the young child's home) in the following manner. The parent or care-giver will position jaw tips 12e, 14e of jaws 12d, 14d in the child's mouth on either side of a non-permanent tooth “T” that is loosely retained in soft tissue “ST” (FIG. 10) of the child's gum and such that angled interior surfaces 22d, 22d on jaw tips 12e, 14e adjacent a base T1“,” “T2” of non-permanent tooth “T”. The parent or care-giver may apply a force to handles 12c, 14c by pushing inwardly in the directions of arrows “A” and “B” (FIG. 11), thereby moving jaw tips 12e, 14e toward each other. As jaw tips 12e, 14e move toward each other they capture non-permanent tooth “T” in the cupped region defined by angled interior surfaces 22d, 22d. The amount of force that can be applied to handles 12c, 14c is limited because handles 12c, 14c tend to flex inwardly toward each other, particularly toward second ends 12b, 14b. The greater the force applied by the parent or care-giver, the more handles 12b, 14b flex or bend toward each other. If sufficient force is applied handles 12b, 14b may be bent to such a degree that they even might contact each other. However, beyond a maximum threshold amount of force applied to handles 12c, 14c, jaw tips 12e, 14e cease to move inwardly toward each other. The maximum threshold amount of force is indicated by the point where handles 12c, 14c start to flex or bend inwardly toward each other but no longer move jaw tips 12e, 14e toward each other. Once tooth “T” is adequately captured between angled interior surfaces 22d, 22d, the parent or care-giver can apply a pulling motion to dental pliers 10 and thereby to tooth “T”, thus extracting the non-permanent tooth “T” from the soft tissue “ST” of the child's gum.

The maximum threshold amount of force that may be applied to handle 12c, 14c may also limited by abutting contact of first spring housing 12h provided on handle 12c and second spring housing 14h on handle 14c. When first spring housing 12h and second spring housing 14h contact each other, further inward motion of the upper ends of handles 12c, 14c (proximate neck regions 12f, 14f) is stopped and thereby movement of jaw tips 12e, 14e towards each other is stopped.

Once tooth “T” has been extracted, the parent or care-giver may place dental pliers 10 into a dishwasher to clean and sanitize dental pliers 10 in the dishwasher.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A pair of dental extraction pliers comprising:
a left leg including a handle and a jaw;
a right leg including a handle and a jaw; wherein the handles of the left leg and right leg are fabricated from a flexible material;
a pivot pin engaging the left and right legs to each other; wherein the handles are movable towards each other or away from each other; and when the handles are moved towards each other, the jaws are moved toward each other; and the flexible material of the handles limits a force that is applied by the jaws; and
wherein each jaw includes:
a base comprising a first region and a second region, where the second region extends outwardly and forwardly from the first region; wherein an interior surface of the first region is oriented at a first angle relative to an interior surface of the second region; wherein the first region of the left leg and the first region of the right leg extend outwardly and forwardly from the pivot pin and angle outwardly away from each other; and the interior surfaces of the first and second regions of the base of the left leg are located opposite the interior surfaces of the first and second regions of the base of the right leg; and
a jaw tip extends outwardly and downwardly from the second region of each base.

2. The pair of dental pliers according to claim 1, wherein the first angle is an obtuse angle.

3. The pair of dental pliers according to claim 1, wherein a lower surface of each jaw tip angles downwardly relative to a lower surface of the second region of the associated base at a second angle of from about 110 degrees up to about 140 degrees.

4. The pair of dental pliers according to claim 1, wherein the jaw tips taper inwardly towards each other when the pair of dental pliers is viewed from above or when the pair of dental pliers is viewed from a front end.

5. The pair of dental pliers according to claim 1, wherein each jaw tip comprises a first section and a second section; where the first section extends outwardly and forwardly from the second region of the associated base, and the second section extends forwardly and inwardly from the first section; and wherein an interior surface of the second section is oriented at a third angle relative to an interior surface of the second section; the jaw tips on the left and right legs are opposed and form a cupped region adapted to receive a tooth therein when the left and right handles are moved to a closed position.

6. The pair of dental pliers according to claim 5, wherein the third angle is from about 10 degrees up to about 40 degrees.

7. The pair of dental pliers according to claim 1, further comprising a spring extending between the handle of the left leg and the handle of the right leg.

8. The pair of dental pliers according to claim 7, further comprising a first spring housing extending outwardly from an interior surface of the handle on the left leg; and a second spring housing extending outwardly from an interior surface of the handle on the right leg; wherein a first end of the spring is seated in the first spring housing and a second end of the spring is seated in the second spring housing.

9. The pair of dental pliers according to claim 8, wherein the first spring housing abuts the second spring housing when the handles are moved to a closed position.

10. The pair of dental pliers according to claim 7, wherein the spring biases the handles into an open position.

11. The pair of dental pliers according to claim 1, wherein the flexible material of the handles is an injection molded plastic.

12. The pair of dental pliers according to claim 11, wherein the flexible material of the handles is overmolded with rubber.

13. The pair of dental pliers according to claim 11, wherein the jaw tips are fabricated from metal.

14. The pair of dental pliers according to claim 13, wherein the jaw tips are fabricated from die-cast aluminum.

15. The pair of dental pliers according to claim 1, wherein the pliers are fabricated from dishwasher-safe materials.

16. A method using a pair of dental pliers comprising steps of:
providing a pair of dental pliers having pivotable left and right legs each including a handle and a jaw; wherein the handles are fabricated from a flexible material; where each jaw includes a base comprising a first region and a second region, where the second region extends outwardly and forwardly from the first region; and an interior surface of the first region is oriented at a first angle relative to an interior surface of the second region; wherein the first region of the left leg and the first region of the right leg extend outwardly and forwardly from the pivot pin and angle outwardly away from each other; and the interior surfaces of the first and second regions of the base of the left leg are located opposite the interior surfaces of the first and second regions of the base of the right leg; and a jaw tip extends outwardly and downwardly at a second angle from the second region of each base.
positioning the jaw tips of the jaws in a child's mouth on either side of a non-permanent tooth that is loosely retained in a soft tissue of the child's gums;
positioning angled interior surfaces on the jaw tips adjacent a base of the non-permanent tooth;
applying a force to the handles;
moving the jaws toward each other;
capturing the non-permanent tooth between the angled interior surfaces of the jaw tips;
limiting an amount of force applied to the non-permanent tooth by the jaws;
applying a pulling motion to the captured non-permanent tooth; and
extracting the non-permanent tooth from the soft tissue.

17. The method according to claim 16, wherein the step of limiting the amount of force comprises:
flexing the flexible material of the left leg's handle and the right leg's handle inwardly toward each other once a maximum threshold force is applied to the left and right leg's handles.

18. The method according to claim 16, wherein the step of limiting comprises:
abutting a first spring housing provided on the left leg's handle against a second spring housing provided on the right leg's handle; and
stopping motion of the left leg's jaw and right leg's jaw towards each other.

19. The method according to claim 16 further comprising:
placing the dental pliers into a dishwasher after extraction of the non-permanent tooth; and
cleaning and sanitizing the dental pliers in the dishwasher.

20. A use of the dental pliers according to claim 16 by a parent or a care-giver of a child in a setting outside of a dental office.

21. The pair of dental pliers according to claim 1, wherein the first region of the base of each jaw is located in a different plane to the jaw tip of the associated base.

22. The pair of dental pliers as defined in claim 1, wherein the second region of the base of each of the jaws on the left leg and the right leg has a terminal end that defines a socket therein; and wherein each jaw tip comprises a shaft and a head; and the shaft is receivable in the socket of the terminal end of the associated base.

23. The pair of dental pliers as defined in claim 5, wherein the interior surface of the second section of each jaw tip is generally aligned with the interior surface of the second region of the associated base.

24. The method according to claim 16, wherein the providing of dental pliers having jaw tips further comprises:
providing the jaw tips as detachable members that include a shaft and a head;
inserting the shaft of each jaw tip into a socket defined at an end of the second region of the base of the jaw of one of the left leg and the right leg of the dental pliers; and
pushing the shaft inwardly until the head abuts the end of the second region of the base of the jaw of the one of the left leg and the right leg of the dental pliers.
